(19) United States
(12) Patent Application Publication
(10) Pub. No.: US 2013/0159108 A1
(43) Pub. Date: Jun. 20, 2013

(54) MAP-BASED MENU INFORMATION NETWORK

(71) Applicant: ReJean DesRosiers, Mississauga (CA)

(72) Inventor: ReJean DesRosiers, Mississauga (CA)

(21) Appl. No.: 13/716,671

(22) Filed: Dec. 17, 2012

Related U.S. Application Data
(60) Provisional application No. 61/576,532, filed on Dec. 16, 2011.

(51) Int. Cl. G06Q 50/12

(52) U.S. Cl. CPC G06Q 50/12; G06Q 30/0627
USPC 705/14.57; 705/26.63

(57) ABSTRACT

A method for creating and managing a restaurant menu can be disclosed. The method can include establishing a restaurant menu; adding one or more menu items to the menu; associating menu item description information with the one or more menu items; and associating menu item location information with the one or more menu items. The menu can be searchable and at least one of the item description information or item location information can be used to display the results of menu searches on a map-based interface.

### RELATED APPLICATIONS

This application claims priority to U.S. Provisional Application 61/576,532, filed Dec. 16, 2011 and entitled MAP-BASED SOCIAL AND ADVERTISING NETWORK, the entire contents of which are hereby incorporated by reference.

### BACKGROUND

Current search engines relating to searches for products and services, especially restaurants and menus, are often difficult to use. Many provide results in text-only format, which makes locating the desired products and services difficult. While some search systems provide mapping functionality, the mapping interface is often poorly integrated with the search results, requiring the user to switch often between a text-based list interface and a location-aware map interface.

In addition, customer comments and reviews, when available, are often difficult to locate, as well as difficult to associate with a particular location. And, even on the most advanced location-based or location-aware products and services searches, it is difficult or impossible for a user to ascertain from the search results, or for a restaurant to properly present, the state of a restaurant's inventory at a particular location, or the presence or absence of sales or other promotional activity.

### SUMMARY

A method for creating and managing a restaurant menu can be disclosed. The method can include establishing a restaurant menu; adding one or more menu items to the menu; associating menu item description information with the one or more menu items; and associating menu item location information with the one or more menu items. The menu can be searchable and at least one of the item description information or item location information can be used to display the results of menu searches on a map-based interface.

A method for following information about a menu item or restaurant can be described. The method can include selecting a menu item or restaurant; setting parameters for the menu item or restaurant; setting location preferences for the menu item or restaurant; setting notification preferences for the menu item or restaurant; setting communication preferences for the menu item or restaurant. The menu item or restaurant can be selected by searching a network using a map-based search interface, and information can be received through the network by at least one of notifications or messages based on at least one of the item parameters, the location preferences, the notification preferences, or the communication preferences.

A method of soliciting information about a wanted item can be disclosed. The method can include creating a want post for an item on a network; setting parameters for the want post; setting location preferences for the want post; setting notification preferences for the want post; and setting communication preferences for the want post. The want post can be searchable on a network using a map-based search interface, and wherein information can be received through the network by at least one of notifications or messages based on at least one of the item parameters, the location preferences, the notification preferences, or the communication preferences.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 shows an exemplary embodiment of a networked computer system.

FIG. 2 shows an exemplary embodiment of a process for establishing a menu.

FIG. 3 shows an exemplary embodiment of a process for placing a menu item on a special sale.

FIG. 4 shows an exemplary embodiment of a process for searching using a map-based interface.

FIG. 5A shows an exemplary embodiment of a map-based search results page.

FIG. 5B shows an exemplary embodiment of a map-based search results page.

FIG. 6 shows an exemplary embodiment of a process for following an item.

FIG. 7 shows an exemplary embodiment of a process for creating a want post.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in a number of different forms, all of which have been contemplated to be within the scope of the claimed subject matter. In addition, for each of the embodiments described herein, the corresponding form of any such embodiments may be described herein as, for example, “a computer configured to” perform the described action.

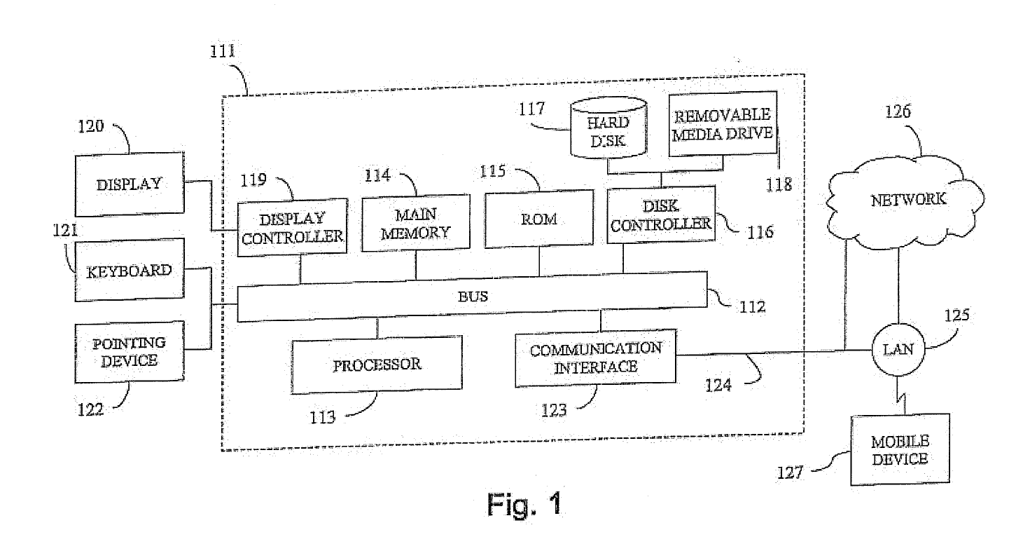

Generally referring to FIGS. 1-7, a network that can be organized around a mapping function and that can be used for information is disclosed. This network can allow users and restaurants to post advertisements for items and services for sale as well as items and services that are sought. It can also allow users to post reviews, both of businesses themselves as well as individual items in the restaurants' inventories or on the restaurants' menus. The network can allow restaurants to easily post and manage coupons and promotions nearly instantaneously.

FIG. 1 illustrates an exemplary computer system 111 upon which an embodiment of the present invention may be implemented. The computer system 111 includes a bus 112 or other communication mechanism for communicating information, and a processor 113 coupled with the bus 112 for processing the information. The computer system 111 also includes a main memory 114, such as a random access memory (RAM) or other dynamic storage device (e.g., dynamic RAM (DRAM), static RAM (SRAM), and synchronous DRAM (SDRAM)), coupled to the bus 112 for storing information and instructions to be executed by processor 113. In addition, the main memory 114 may be used for storing temporary variables or other intermediate information during the execution of instructions by the processor 113. The computer system 111 further includes a read only memory (ROM) 115 or other static storage device (e.g., programmable ROM (PROM), erasable PROM (EPROM), and electrically erasable PROM (EEPROM)) coupled to the bus 112 for storing static information and instructions for the processor 113.

The computer system 111 also includes a disk controller 116 coupled to the bus 112 to control one or more storage devices for storing information and instructions, such as a magnetic hard disk 117, and a removable media drive 118 (e.g., floppy disk drive, read-only compact disc drive, read/write compact disc drive, compact disc jukebox, tape drive, and removable magneto-optical drive). The storage devices may be added to the computer system 111 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system known to one having ordinary skill in the art. The database may be provided, for example, as a database management system (DBMS), a relational database management system (e.g., DB2, ACCESS, etc.), an object-oriented database management system (ODBMS), a file system or another conventional database package as a few non-limiting examples. The database can be accessed via a Structure Query Language (SQL) or other tools known to one having skill in the art.

Still referring to FIG. 1, the computer system 111 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 111 may also include a display controller 119 coupled to bus 112 to control a display 120, such as a cathode ray tube (CRT), liquid crystal display (LCD) or any other type of display, for displaying information to a computer client. The computer system includes input devices, such as a keyboard 121 and a pointing device 122, for interacting with a computer client and providing information to the processor 113. Additionally, a touch screen could be employed in conjunction with display 120. The pointing device 122, for example, may be a mouse, a trackball, or a pointing stick for communicating direction information and command selections to the processor 113 and for controlling cursor movement on the display 120. In addition, a printer may provide printed listings of data stored and/or generated by the computer system 111.

The computer system 111 performs a portion or all of the processing steps of the invention in response to the processor 113 executing one or more sequences of one or more instructions contained in a memory, such as the main memory 114. Such instructions may be read into the mar memory 114 from another computer readable medium, such as a hard disk 117 or a removable media drive 118. One or more processors in a multi-processing arrangement may also be employed to execute the sequences of instructions contained in main memory 114. In alternative embodiments, hard-wired circuitry may be used in place of or in combination with software instructions. Thus, embodiments are not limited to any specific combination of hardware circuitry and software.

As stated above, the computer system 111 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 111, for driving a device or devices for implementing the invention, and for enabling the computer system 111 to interact with a human client. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 113 for execution. A computer readable medium may take many forms, including but not limited to, non-volatile media, volatile media, and transmission media. Non-volatile media includes, for example, optical, magnetic disks, and magneto-optical disks, such as the hard disk 117 or the removable media drive 118. Volatile media includes dynamic memory, such as the main memory 114. Transmission media includes coaxial cables, copper wire and fiber optics, including the wires that make up the bus 112. Transmission media also may also take the form of acoustic or light waves, such as those generated during radio wave and infrared data communications.

Various forms of computer readable media may be involved in carrying out one or more sequences of one or more instructions to processor 113 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 111 may receive the data on the telephone line and use an infrared transmitter to convert the data to an infrared signal. An infrared detector coupled to the bus 112 can receive the data carried in the infrared signal and place the data on the bus 112. The bus 112 carries the data to the main memory 114, from which the processor 113 retrieves and executes the instructions. The instructions received by the main memory 114 may optionally be stored on storage device 117 or 118 either before or after execution by processor 113.

The computer system 111 also includes a communication interface 123 coupled to the bus 112. The communication interface 123 provides a two-way data communication coupling to a network link 124 that is connected to, for example, a local area network (LAN) 125, or to another communications network 126 such as the Internet. For example, the communication interface 123 may be a network interface card to attach to any packet switched LAN. As another example, the communication interface 123 may be a wireless link. In any such implementation, the communication interface 123 sends and receives electrical, electromagnetic or optical signals that carry digital data streams representing various types of information.

The network link 124 typically provides data communication through one or more networks to other data devices. For example, the network link 124 may provide a connection to another computer or remotely located presentation device through a local network 125 (e.g., an 802.11-compliant wireless network) or through equipment operated by a service provider, which provides communication services through a communications network 126. In preferred embodiments, the local network 124 and the communications network 126 preferably use electrical, electromagnetic, or optical signals that carry digital data streams. The signals through the various networks and the signals on the network link 124 and through the communication interface 123, which carry the digital data to and from the computer system 111, are exemplary forms of carrier waves transporting the information. The computer system 111 can transmit and receive data, including program code, through the network(s) 125 and 126, the network link 124 and the communication interface 123. Moreover, the network link 124 may provide a connection through a LAN 125 to a mobile device 127 such as a personal digital assistant (PDA) laptop computer, or cellular telephone. The LAN communications network 125 and the communications network 126 both use electrical, electromagnetic or optical signals that carry digital data streams. The signals through the various networks and the signals on the network link 124 and through the communication interface 123, which carry the digital data to and from the system 111, are exemplary forms of carrier waves transporting the information. The processor system 111 can transmit notifications and receive data, including program code, through the network(s), the network link 124 and the communication interface 123.

In some embodiments, computation, software, data access, storage, and any other desired function can be run, hosted, stored, or otherwise accomplished in a cloud-based, cloud-enabled, or otherwise cloud-related network, which can be low cost and easily expanded as needs require

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission.

In some exemplary embodiments, a network, hereinafter referred to the Uppost network, can include an inventory management system. The inventory management system can allow restaurants to provide inventories of available items. The inventories can be fine-grained, and can allow a restaurant to provide information on each individual menu item or type of item offered by the restaurant. These inventories can be accessed through any desired searching tool known in the art, for instance search engines. In some exemplary embodiments, these inventories can be accessed by users through a map-based search engine implemented on a computer network, as described below. This can allow users to gather information on menu items offered by the restaurant prior to or in preparation for purchase.

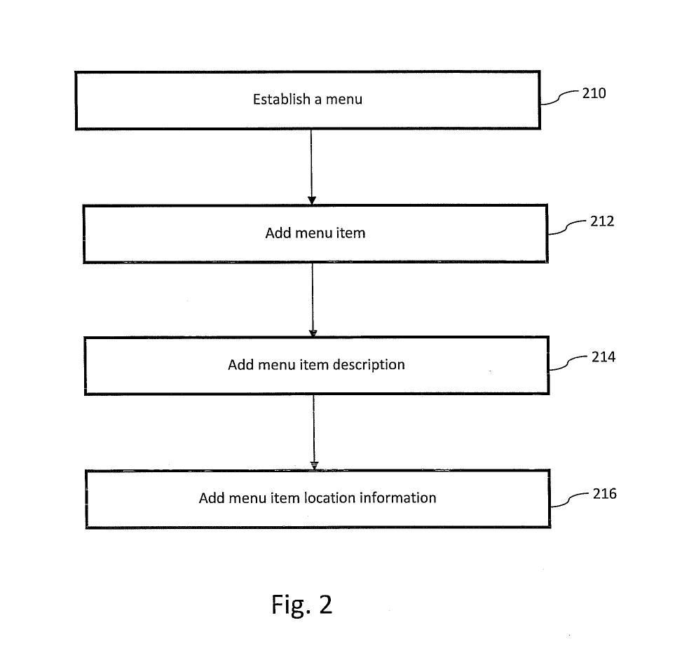

FIG. 2 shows an exemplary embodiment of a process for creating and populating a restaurant menu on an exemplary embodiment of the Uppost network. At step 210, a restaurant can establish a menu. This menu can be associated with a single physical location, for example a single restaurant location, multiple physical locations, for example a chain of restaurants, or no physical location, as desired. At step 212, a restaurant can add a listing for an item, type of item, service, or type of service to the menu. If desired, restaurants can create multiple separate menus for separate locations, in order to provide, for example, separate sets of listings representing the current stock offered at each particular location.

Still referring to FIG. 2, at step 214 a restaurant can add descriptive information to an individual menu item listing. In some embodiments, the Uppost network can automatically create an in-depth informational post for each individual menu item. The in-depth informational post can be, for example, five pages long, can consist of the menu item description, photos of the menu item, video of the menu item, comments from the public about the menu item, and a space for the user to send an electronic reservation for the restaurant. In addition, the in-depth informational post can also include a tool to communicate with the restaurant through a message system or other communication tool. The Uppost network can also generate a pop-up display which can be viewed on a map-based interface as a search result, as described below, and which can provide access to the in-depth informational post for a user viewing the map-based interface.

Still referring to FIG. 2, at step 216 a restaurant can associate location information with a listing. The restaurant can select to post each menu item at an exact address within a city, or within a city, or a number of cities, states or provinces, country or countries, or any other desired geographical area all over the world. This location information can be useful for users, and can be accessed by any desired search tool, for example a map-based search tool as described below.

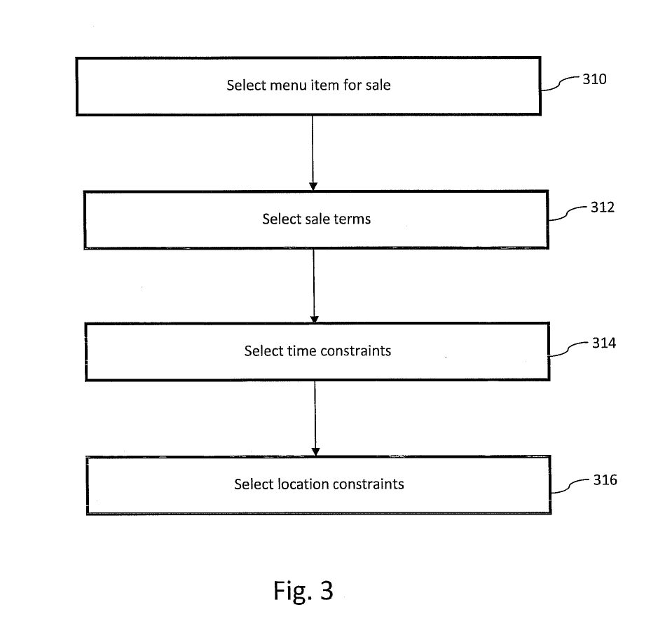

In some exemplary embodiments, the Uppost network can allow restaurants to conduct sales, create coupons, or offer a menu item under any other special condition. FIG. 3 shows an exemplary embodiment of a process for creating a sale, coupon, or special on an exemplary embodiment of the Uppost network. At step 310, a restaurant can select a menu item to which the sale, coupon, or other special is to be applied. The restaurant can select individual menu items, or can select group menu items in any configuration as desired. At step 312, the restaurant can select the terms of the sale. These terms can be any sale terms as desired, and can include any combination of special prices, discounts, or any other kinds of incentive. The terms can limit the sale to a certain number of products or services, and can list the number remaining, which can be updated by the restaurant as the sale progresses. In some embodiments, the specials or other promotions can list the number of inquiries received for a menu item, or the number of purchases made of the menu item, and can compare these numbers to the number of items remaining, or any other desired information. At step 314, the restaurant can select time constraints for the sale, if and as desired. The restaurant can put an item on special at any time of the day, and can also end the sale at any time. The restaurant can create sales, coupons, or other specials that can be for a set period of time and can be recurring, for instance hourly, daily, weekly, or any other desired period of time. At step 316, the restaurant can set location constraints for the sale, coupon, or other special, if and as desired. The Uppost network can allow a restaurant to to target any market or markets, as desired, by restricting the application of the special to particular physical locations.

In some exemplary embodiments, the Uppost network can allow users to make reservations. Reservations can be made for a particular menu item or type of menu item. A restaurant can set terms of the reservation, for example pick up times or limitations such as time limits. The restaurant can associate a reservation with a sale, coupon, or other special, for example giving a discount on an item or service for making a reservation at a particular time. The restaurant can require a deposit, if desired.

In some exemplary embodiments, the Uppost network can allow users to complete purchases entirely through the Uppost network. These purchases can be initiated from an in-depth informational post for menu item, or from any other location or page. The Uppost network can allow a user to select an menu item for purchase, render payment, arrange delivery, receive confirmation, and undergo any other desired action in order to complete a sale.

In some embodiments, the Uppost network can allow users to make and view comments. Any user, including general public and business users, can comment on menu items, services offered, business, or other users. Users can also make general posts tied to a specific geographical location or in any other desired manner. The comments can serve as reviews, as social communication, as reminders, as informational posts, or have any other desired function.

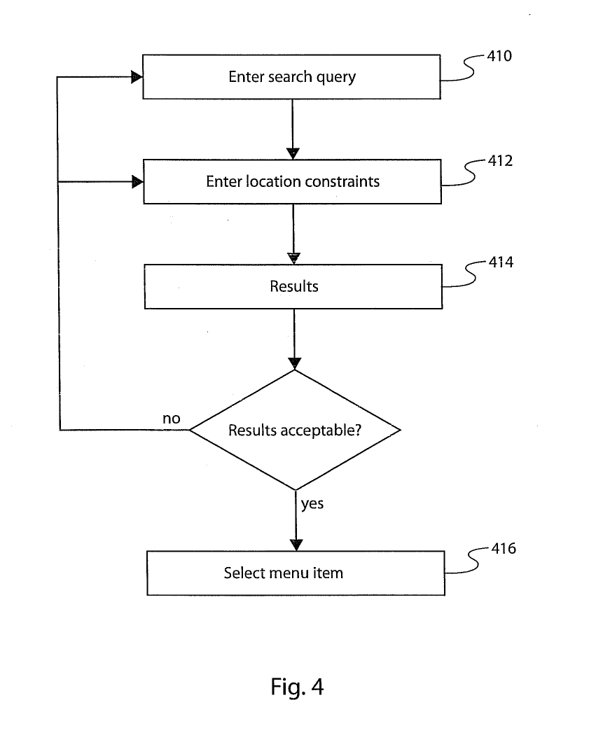

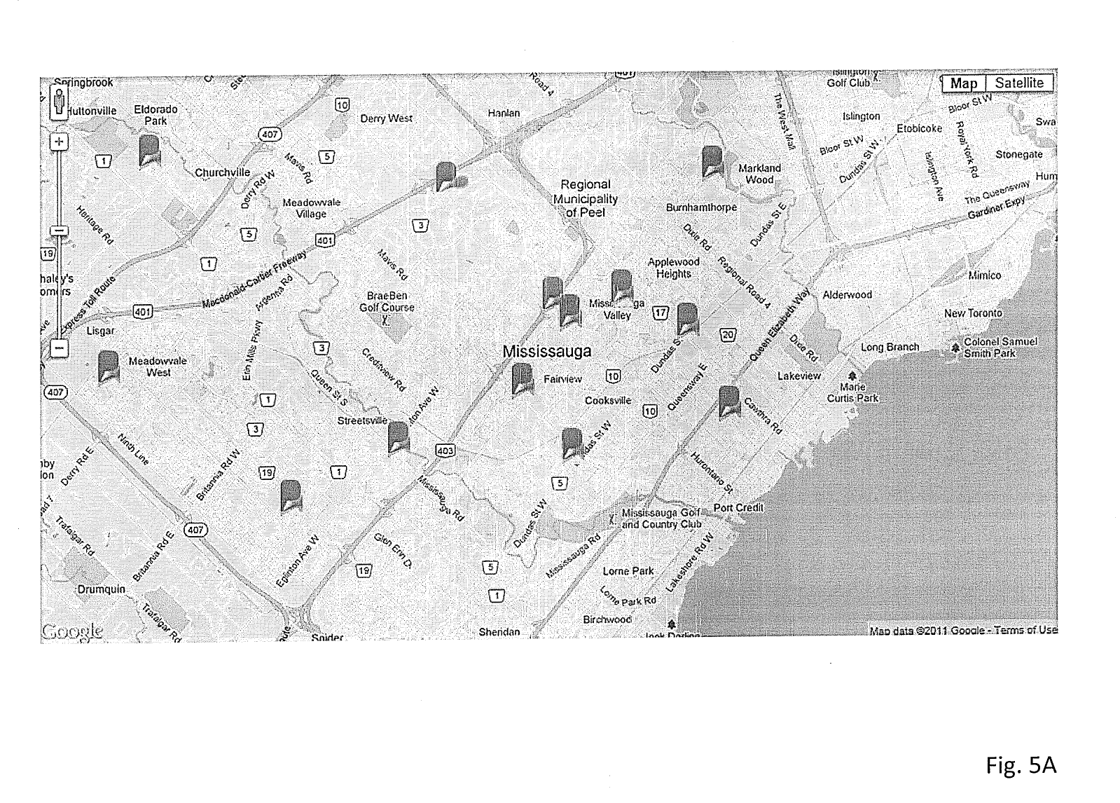

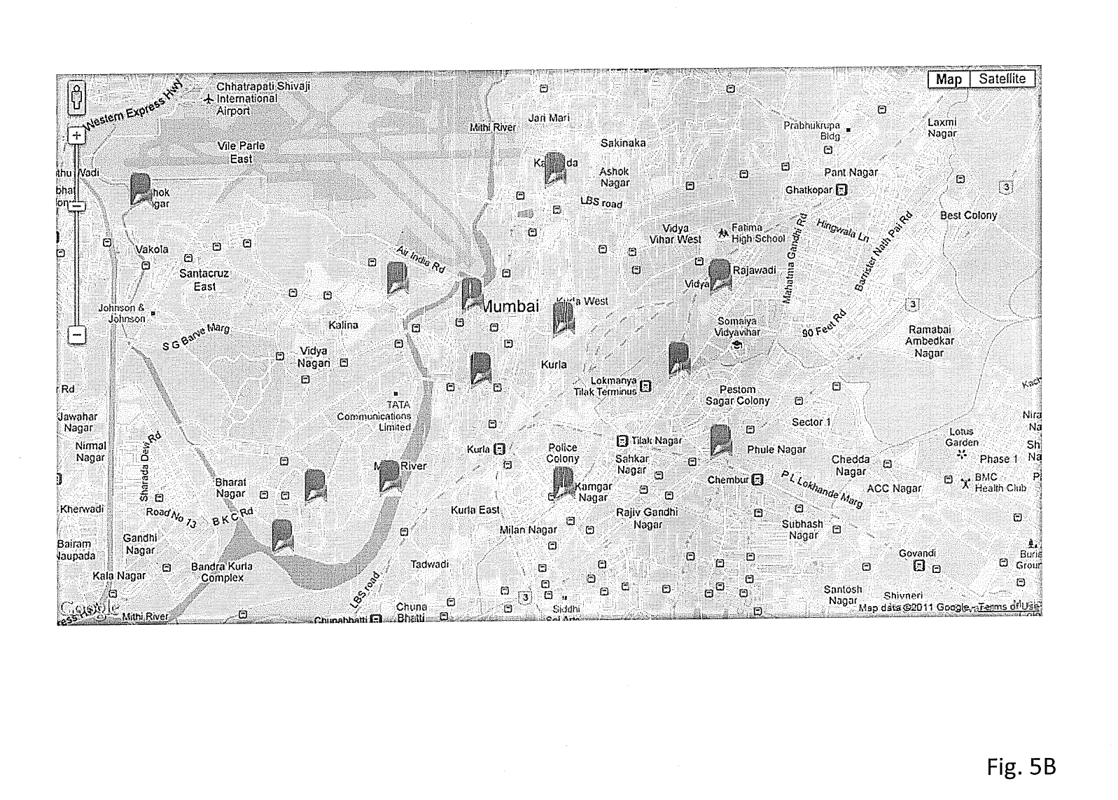

FIG. 4 shows an exemplary embodiment of a process for searching using a map-based interface. FIGS. 5A and 5B show an exemplary embodiment of a map-based results page. A user can search using any search tool, for example a networked computer system, a mobile communication device, or any other device or tool as desired. The results of the search can contain or include menus that have been established by restaurants, as described above. At step 410, the user can enter a search query. The search query can be in the form of a text query, and can be for example a name or description of a menu item. The search query can also be in the form of a picture, such as a picture of a product, or a picture of a product identifier such as the Universal Product Code (UPC). The Uppost network can interpret any type product identifier, for example UPCs, including UPC-B, UPC-C, UPC-D, or UPC-5, as well as European Article Numbers (EANs) or International Article Numbers, or any other type of barcode or other identification scheme. The search query can also take any other desired form, such as any type of scan or any other form as desired.

Still referring to FIG. 4, at step 412 the user can, if desired, enter a location to be associated with the search query. The user can enter the location by supplying coordinates, supplying a location identifier such as a place name, address, postal code such as Zone Improvement Plan (ZIP) code or any other code or identifier, as desired. The user can also enter the location using a map-based interface such as an interactive map. Using an interactive map, the user can zoom in, zoom out, relocate the viewing area, or perform any other interaction as desired. The location entered can be specific, or it can be a general location such as a city, county, state, country, region, continent, body of water, planet, or any other type of location.

Still referring to FIG. 4, at step 414 the user can review the results of the search. The user can review the results in any form, for example a list. In some embodiments, the results of the search can be displayed on a map-based interface such as an interactive map. The network can automatically return results containing restaurants or other sellers organized by price, by location, by proximity to a desired location, or any other desired criteria. In some embodiments, the results can take the form of informational posts displayed on the map. The informational posts can represent menu items associated with physical locations by restaurants as described above. Users can select the map boundaries used to display the results of a search as well as the desired size of the results displayed, for example from within one block to all over the world. Results can include, for example, businesses or restaurants with a physical location, and can also include business, restaurants, and other entities which are online-only.

Users can determine whether the results supplied at step 414 are acceptable. If one or more of the displayed results are acceptable, the user can move to step 416 and interact with the results by, for example, selecting an informational post that can provide more information. If none of the results are acceptable, the user can return to step 410 in order to enter different search criteria, or to step 412 in order to refine the desired location by manipulating the map-based interface, for example by moving the map or by zooming in and out.

In some exemplary embodiments, the Uppost network can make use of voice integration. Any function described in this application can be accomplished through the use of voice-based commands, including creating upposts, executing searches, navigating interfaces, and any other desired function.

In some exemplary embodiments, the Uppost network can allow anonymous or pseudonymous communication between users of the service, for example between buyers and sellers. These messages can be exchanged, for instance, between a restaurant and one or more users interested in a menu item, or between a potential buyer of a menu item and another user who has already bought that same or similar menu item, or for any other desired communication between any combination of users, restaurants, and any other participants. The messages can be sent anonymously, or pseudonymously using a nickname or username, so that, for example, a user's personal details are not exposed before the user wishes them to be.

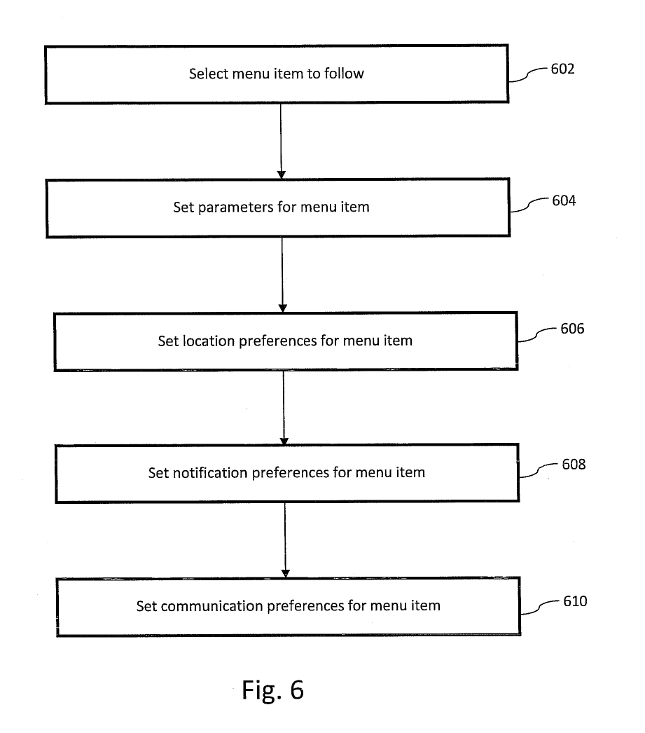

In some exemplary embodiments, the Uppost network can allow a user to follow a restaurant or menu item. FIG. 6 shows an exemplary embodiment of a process for following a menu item using the Uppost network. At step 602, a user can select a menu item to be followed. The Uppost network can allow users to follow any desired menu item, for example a general class of menu items, a specific menu item, a general type of restaurant, a specific restaurant, or a particular location of a specific restaurant. In addition, the Uppost network can also allow users to follow any other desired information or post, for example posts submitted by other users, location descriptions, photographs, videos, or any other type of information as desired. In some exemplary embodiments, menu items or restaurants to be followed can be selected from search results obtained as described above. In some exemplary embodiments, a user can enter a general description of a menu item or restaurant and the Uppost network can automatically select an appropriate item to be followed.

Still referring to FIG. 6, at step 604 a user can set parameters for the menu item or restaurant to be followed. The parameters can include any desired feature of the menu item or restaurant to be followed. In some exemplary embodiments, a user can choose to follow, for example, a menu item with, for example a specific ingredient, cooking method, regional style, or any other feature as desired. A user can choose to follow a menu item offered at a particular time or range of times, or at a particular price or range of prices. A user can also choose to follow, for example, restaurants with particular features such as style of food, opening and closing times, menu items, special accommodations, or any other desired feature. A user can also choose to follow, for example, informational posts from a specific other user or group of users, informational posts about a specific topic, or informational posts which are posted at a specific time.

Still referring to FIG. 6, at step 606 a user can set a location preference for the item to be followed. In some exemplary embodiments, a user can, for example, choose to follow a menu item offered in a specific location or range of locations. A user can, for example, choose to follow a menu item offered at one particular location, such as one of several storefronts operated by a restaurant. A user can also choose to follow a menu item offered by any restaurant within a range of locations. A user can also choose to follow, for example, an informational post, picture, video, or other post located at or regarding a specific location or range of locations.

Still referring to FIG. 6, at step 608 a user can set notification preferences for the menu item or restaurant to be followed. A user can be notified every time another user, for example a restaurant, makes a post or updates a post about the menu item being followed. A user can receive notifications on a menu item from all restaurants, or the user can specify one or more particular restaurants about which to receive notifications. A user can also choose to receive, for example, notifications about a changes or additions to an informational post made by another user. A user can also choose to receive, for example, notifications about comments made by another user on a post, for example product reviews for a followed item, or comments made on a followed photograph or video. A user can also choose to receive, for example, notifications about new informational posts made about a followed restaurant.

Still referring to FIG. 6, at step 610 a user can set communication preferences for an item to be followed. The restaurant that has been followed can send messages or other notifications to followers, for example special offers or further description of the menu items.

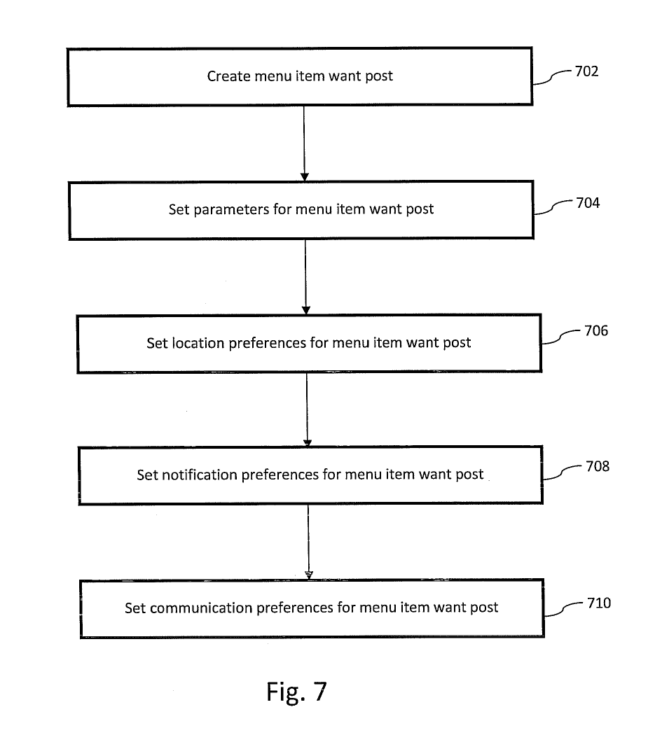

In some exemplary embodiments, the Uppost network can allow users to post a want post about a specific menu item that they want or seek. FIG. 7 shows an exemplary embodiment of a process for creating a want post. In some exemplary embodiments, want posts can be searchable through, for example, a map-based interface as described above. Other users can search want posts and provide information about a wanted item to the creator of a want post.

Still referring to FIG. 7, at step 702 a user can create a want post. The Uppost network can allow users to create a want post for any desired menu item, for example a general class of menu items, a specific ingredient, a specific cooking method, a specific style of food, or a specific item. In addition, the Uppost network can also allow users to create a want post for information, for example information submitted by other users, location descriptions, photographs; videos, or any other type of information as desired. In some exemplary embodiments, a user can enter a general description of a menu item. In some exemplary embodiments, wanted items can be selected from search results obtained as described above.

Still referring to FIG. 7, at step 704 a user can set parameters for the wanted item. The parameters can include any desired feature of the wanted item. In some exemplary embodiments, a user can create a want post for a product with, for example, a specific ingredient, cooking method, regional style, or any other feature as desired. A user can create a want post for a menu item offered at a particular time or range of times, or at a particular price or range of prices. A user can also create a want post for, for example, restaurants with particular features such as style of food, opening and closing times, menu items, special accommodations, or any other desired feature. A user can also create a want post for, for example, informational posts from a specific other user or group of users, informational posts about a specific topic, or informational posts which are posted at a specific time.

Still referring to FIG. 7, at step 706 a user can set a location preference for the want post. In some exemplary embodiments, a user can, for example, create a want post for an item offered in a specific location or range of locations. A user can, for example, create a want post for a menu item offered at one particular location, for example one of several storefronts operated by a restaurant. A user can also create a want post for a menu item offered by any restaurant within a range of locations. A user can also create a want post for, for example, an informational post, picture, video, or other post located at or regarding a specific location or range of locations.

Still referring to FIG. 7, at step 708 a user can set notification preferences for a want post. In some exemplary embodiments, other users, including restaurants, can notify the creator of a want post about where the wanted item is available. The notification can include details about the item, for example price and location. If the want post is, for example, about a menu item, the notification can include information about features such as specific ingredient, cooking method, regional style, or any other feature as desired.

Still referring to FIG. 7, at step 710 a user can set communication preferences for the want post. A user can choose to receive messages from a particular restaurant. A user can also, for example, choose to receive messages from previous restaurant customers, or other users which have information regarding the wanted item or similar items. The messages can be about any desired topic, for example special offers or further description of the item.

In some exemplary embodiments, the Uppost network can allow anonymous or pseudonymous communication between users of the service, for example between buyers and sellers. These messages can be exchanged, for instance, between a business selling a product or services and one or more users following the product or service, or between a potential buyer of a product and another user who has already bought that same or similar product, or for any other desired communication between any combination of general public users and businesses in the Uppost network. The messages can be sent anonymously, or pseudonymously using a nickname or username, so that a user's personal details are not exposed before the user wishes them to be.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for creating and managing a restaurant menu, comprising:
establishing a restaurant menu;
adding one or more menu items to the menu;
associating menu item description information with the one or more menu items; and
associating menu item location information with the one or more menu items;
wherein the menu is searchable and at least one of the item description information or item location information are used to display the results of menu searches on a map-based interface.

2. The method of claim 1, wherein the results of menu searches are organized by at least one of price, current location, or proximity to a desired location.

3. The method of claim 1, wherein a user interacts with the map-based interface by redefining the boundaries of the map-based interface.

4. The method of claim 1, wherein the menu item description information includes at least one of an item description, a photograph of the item, a video of the item, comments about the item from a previous purchaser of the item, or information regarding the terms and procedures for sale of the item.

5. The method of claim 1, further comprising sending one or messages between a creator of a menu and a user.

6. The method of claim 1, further comprising:
selecting a menu item for a special sale;
selecting sale terms for the special sale;
selecting time constraints for the special sale;
selecting location constraints for the special sale;
wherein at least one of the sale terms, time constraints, or location constraints are included in the menu search results.

7. The method of claim 6, wherein the terms for the special sale include at least one of a menu item purchase limit or a total number of menu items to be sold in the special sale.

8. The method of claim 6, wherein the location constraints of the special sale restrict the special sale to a specific location.

9. The method of claim 6, wherein the menu search results include at least one of the number of menu items remaining, the number of items sold, or the number of search queries received.

10. A method for following information about menu item or restaurant, comprising:
selecting a menu item or restaurant;
setting parameters for the menu item or restaurant;
setting location preferences for the menu item or restaurant;
setting notification preferences for the menu item or restaurant;
setting communication preferences for the menu item or restaurant;
wherein the menu item or restaurant is selected by searching a network using a map-based search interface, and wherein information is received through the network by at least one of notifications or messages based on at least one of the item parameters, the location preferences, the notification preferences, or the communication preferences.

11. The method of claim 10, wherein the item is a menu item, and the parameters include at least one of ingredient, cooking method, or regional style.

12. The method of claim 10, wherein the item is a restaurant, and the parameters include at least one of opening or closing times, inventory items, or special accommodations

13. The method of claim 10, wherein the item is an informational post, and the parameters include at least one of a specific other user or group of users, a specific topic, a specific time.

14. The method of claim 10, wherein the location preferences are for a location or range of locations, and are established using a map-based search interface.

15. A method of soliciting information about a wanted item, comprising:
creating a want post for an item on a network;
setting parameters for the want post;
setting location preferences for the want post;
setting notification preferences for the want post;
setting communication preferences for the want post;
wherein the want post is searchable on a network using a map-based search interface, and wherein information is received through the network by at least one of notifications or messages based on at least one of the item parameters, the location preferences, the notification preferences, or the communication preferences.

16. The method of claim 15, wherein the item is a menu item, and the parameters include at least one of ingredient, cooking method, or regional style.

17. The method of claim 15, wherein the item is a restaurant, and the parameters include at least one of opening or closing times, inventory items, or special accommodations.

18. The method of claim 15, wherein the item is an informational post, and the parameters include at least one of a specific other user or group of users, a specific topic, or a specific time.

19. The method of claim 15, wherein the location preferences are for a location or range of locations, and are established using a map-based search interface.
